(19) United States
(12) Patent Application Publication
(10) Pub. No.: US 2014/0306942 A1
(43) Pub. Date: Oct. 16, 2014

(54) DISPLAY APPARATUS

(71) Applicant: SAMSUNG DISPLAY CO., LTD., Yongin-City (KR)

(72) Inventor: HyeongCheol AHN, Yongin-City (KR)

(73) Assignee: SAMSUNG DISPLAY CO., LTD., Yongin-City (KR)

(21) Appl. No.: 14/228,301

(22) Filed: Mar. 28, 2014

(30) Foreign Application Priority Data
Apr. 11, 2013 (KR) 10-2013-0039873

(51) Int. Cl. G09G 3/36; G09G 3/34

(52) U.S. Cl. CPC G09G 3/36; G09G 3/3406
USPC 345/206; 345/102

(57) ABSTRACT

A display apparatus includes a flexible display panel including a terminal part, the terminal part being configured to receive a driving signal, a window assembly covering the display panel, and a driving circuit film coupled to the terminal part of the display panel, the driving circuit film being configured to apply the driving signal to the display panel, and at least one of the terminal part and the driving circuit film being fixed to the window assembly.

### CROSS-REFERENCE TO RELATED APPLICATION

Korean Patent Application No. 10-2013-0039873, filed on Apr. 11, 2013, in the Korean Intellectual Property Office, and entitled: “Display Apparatus,” is incorporated by reference herein in its entirety.

### BACKGROUND

1. Field

The present disclosure relates to a display apparatus. More particularly, the present disclosure relates to a display apparatus having a flexible property.

2. Description of the Related Art

In recent years, a display apparatus including a flexible display panel has been developed. The flexible display panel includes a flexible base substrate, e.g., a plastic substrate, a plastic film, a metal substrate with a thin film, etc., and pixels arranged on the flexible base substrate. The flexible display panel may be used, e.g., for mobile electronics.

### SUMMARY

Embodiments provide a display apparatus including a flexible display panel including a terminal part, the terminal part being configured to receive a driving signal, a window assembly covering the display panel, and a driving circuit film coupled to the terminal part of the display panel, the driving circuit film being configured to apply the driving signal to the display panel, and at least one of the terminal part and the driving circuit film being fixed to the window assembly.

The driving circuit film may include a bent portion, the bent portion being bent away from the window assembly.

The display apparatus may further include a driving circuit board parallel to the window assembly, the display panel being between the driving circuit board and the window assembly, a first end portion of the driving circuit film being coupled to the terminal part of the display panel, a second end portion of the driving circuit film being coupled to the driving circuit board, and a bent portion of the driving circuit film being bent from the terminal part to the driving circuit board.

The window assembly may include a window substrate including a light transmission part corresponding to a display area of the display panel, a touch screen panel on the window substrate, the touch screen panel being configured to sense a position of a touch event on the window substrate, and a first adhesive member on the touch screen panel, the first adhesive member connecting the touch screen panel to the display panel.

A portion of the driving circuit film coupled to the terminal part of the display panel may be connected to the first adhesive member, the terminal part of the display panel being fixed to the window assembly via the driving circuit film and the first adhesive member.

The display apparatus may further include a second adhesive member, a first surface of the second adhesive member being adhered to at least one of the terminal part and a portion of the driving circuit film coupled to the terminal part, and a second surface of the second adhesive member being adhered to the first adhesive member.

The display panel may further include a display substrate configured to emit light and to display an image using the emitted light, and an optical film having a first surface adhered to the display substrate and a second surface, which faces the first surface, adhered to the first adhesive member, the second adhesive member having a same thickness as a thickness of the optical film.

The display panel may be an organic electroluminescent light emitting display panel.

The display apparatus may further include a backlight assembly facing the window assembly, the backlight assembly being configured output light to the display panel, and the display panel being a liquid crystal display panel between the backlight assembly and the window assembly.

The display apparatus may further include a second adhesive member on at least one of the terminal part and a portion of the driving circuit film coupled to the terminal part, the second adhesive member being directly on the touch screen panel and affixing the terminal part to the window assembly.

The first adhesive member may be transparent, the first adhesive member having a shape corresponding to the touch screen panel.

The window assembly may include a window substrate including a light transmission part corresponding to a display area of the display panel, a touch screen panel on the window substrate, the touch screen panel being configured to sense a position of a touch event on the window substrate, and a first adhesive member on the window substrate, the first adhesive member connecting the window substrate to the display panel.

At least one of the terminal part and a portion of the driving circuit film coupled to the terminal part may be adhered to the first adhesive member, the terminal part being fixed to the window assembly via the portion of the driving circuit film and the first adhesive member.

The display apparatus may further include a second adhesive member adhered to at least one of the terminal part and a portion of the driving circuit film coupled to the terminal part, the terminal part being fixed to the window assembly via the portion of the driving circuit film, the first adhesive member, and the second adhesive member.

The display panel may further include a display substrate configured to emit light to display an image using the light, and an optical film including a first surface adhered to the display substrate and a second surface, which faces the first surface, adhered to the first adhesive member, the second adhesive member having a same thickness as a thickness of the optical film.

The display apparatus may further include a second adhesive member adhered to at least one of the terminal part and the portion of the driving circuit film coupled to the terminal part, the second adhesive member being directly on the window substrate, the terminal part being affixed to the window assembly via the portion of the driving circuit film and the second adhesive member.

The driving circuit film may include a driving chip configured to generate the driving signal, the driving chip being on the driving circuit film in a chip-on-flexible board structure.

### BRIEF DESCRIPTION OF THE DRAWINGS

Features will become apparent to those of ordinary skill in the art by describing in detail exemplary embodiments with reference to the attached drawings, in which:

FIG. 1 illustrates an exploded perspective view of a display apparatus according to an exemplary embodiment of the present disclosure;

FIG. 2 illustrates a cross-sectional view taken along line I-I′ of FIG. 1;

FIG. 3 illustrates a cross-sectional view of a display apparatus according to another exemplary embodiment of the present disclosure;

FIG. 4 illustrates a cross-sectional view of a display apparatus according to another exemplary embodiment of the present disclosure;

FIG. 5 illustrates a cross-sectional view of a display apparatus according to another exemplary embodiment of the present disclosure;

FIG. 6 illustrates a cross-sectional view of a display apparatus according to another exemplary embodiment of the present disclosure;

FIG. 7 illustrates a cross-sectional view of a display apparatus according to another exemplary embodiment of the present disclosure; and

FIG. 8 illustrates a cross-sectional view of a display apparatus according to another exemplary embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure will be explained in detail with reference to the accompanying drawings.

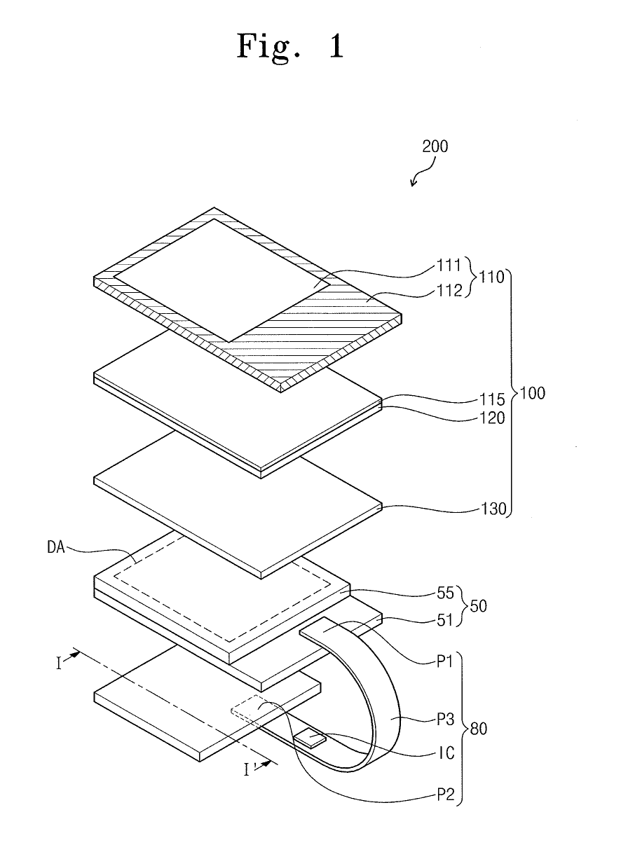

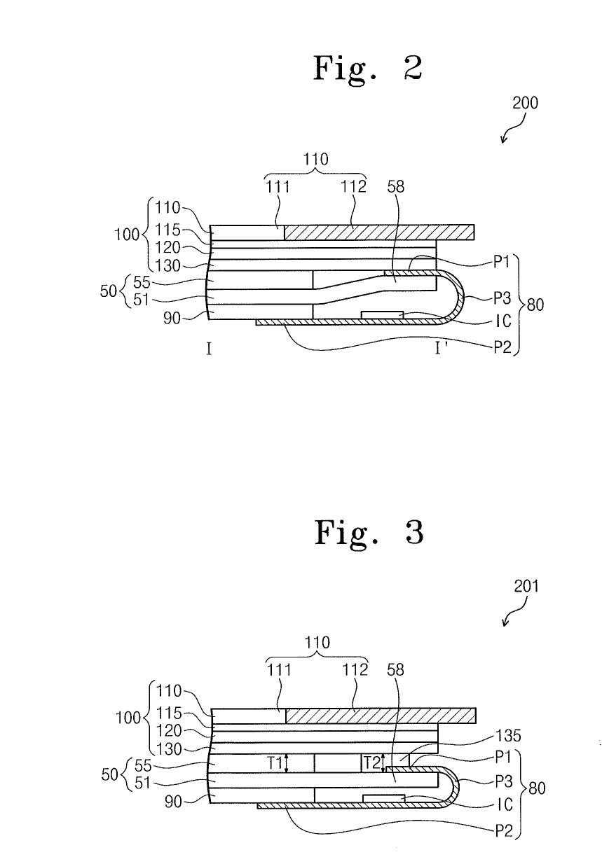

FIG. 1 illustrates an exploded perspective view of a display apparatus according to an exemplary embodiment of the present disclosure, and FIG. 2 illustrates a cross-sectional view taken along line I-I′ of FIG. 1.

Referring to FIGS. 1 and 2, a display apparatus 200 may include a display panel 50, a driving circuit film 80, a driving circuit board 90, and a window assembly 100. In addition to the above-described elements, the display apparatus 200 may further include other elements, e.g., a housing that accommodates the above-described elements. However, descriptions of other elements, except for the above-described elements, will be omitted in FIGS. 1 and 2.

The display panel 50 emits light to display an image using the light. In the present exemplary embodiment, the display panel 50 has a flexible property, i.e., exhibits flexibility. The display panel 50 may be, but not limited to, an organic electroluminescent light emitting display panel. In this case, the display panel 50 may include a display substrate 51 and an optical film 55 disposed on the display substrate 51.

The display substrate 51 may include a base substrate having the flexible property, e.g., a plastic substrate, a plastic film, a metal substrate with a thin film shape, etc., and a plurality of pixels disposed on the base substrate. The pixels may be realized by organic electroluminescent light emitting diodes. In addition, the optical film 55 may include a polarizing film (not shown) and a phase difference film (not shown). The polarizing film polarizes light incident on the display substrate 51 and light reflected from the display substrate 51. In this case, the phase difference film is disposed closer to the display substrate 51 than to the polarizing film to control a phase of the incident light and the reflected light.

Also, the display substrate 51 may include a terminal part 58 that receives a driving signal used to display the image. The terminal part 58 is disposed at one side of the display substrate 51 and includes a plurality of signal lines electrically connected to the pixels or bonding pads electrically connected to the signal lines in a one-to-one correspondence relationship.

The driving circuit film 80 may include an insulating film having a flexible property, e.g., a plastic film, and a plurality of conductive lines disposed on the insulating film. The driving circuit film 80 is coupled to the display panel 50 and the driving circuit board 90 to electrically connect the display panel 50 and the driving circuit board 90. In detail, first terminals (not shown) disposed at a first end portion P1 of the driving circuit film 80 may be electrically connected to the terminal part 58 of the display panel 50 and second terminals (not shown) disposed at a second end portion P2 of the driving circuit film 80 may be electrically connected to a terminal part (not shown) of the driving circuit board 90. In the present exemplary embodiment, the driving circuit film 80 may further include a driving IC chip to generate the driving signal, e.g., the driving IC chip may be mounted on the driving circuit film 80 in a chip-on-flexible board (COF) method.

The driving circuit board 90 is disposed to face the window assembly 100 while interposing the display panel 50 therebetween. In the present exemplary embodiment, a timing controller may be mounted on the driving circuit board 90. The timing controller generates a control signal to control the image displayed in the display panel 50, and the control signal is applied to the driving IC chip through the driving circuit film 80. In addition, plural electronic parts, which control various functions of the display apparatus 200, may be mounted on the driving circuit board 90. For instance, a camera module, a speaker module, and memory chips, which are operated in connection with the display panel 50, may be mounted on the driving circuit board 90.

As described above, since the display panel 50 is disposed between the window assembly 100 and the driving circuit board 90, the driving circuit film 80 is bent, so that the driving circuit film 80 is easily coupled to the terminal part 58 of the display panel 50 and to the driving circuit board 90. In other words, when the driving circuit film 80 has a structure that is extended from the first end portion P1 to the second end portion P2, the driving circuit film 80 includes a bent portion P3 disposed between the first end portion P1 and the second end portion P2. In more detail, the bent portion P3 is bent from the terminal part 58 to the driving circuit board 90, e.g., the bent portion P3 is bent in a direction extending away from the window assembly 100.

The window assembly 100 covers the display panel 50. The window assembly 100 may include a window substrate 110, a touch screen panel 120, a first adhesive member 130, and a sub-adhesive member 115.

In the present exemplary embodiment, the window substrate 110 may include a light transmission part 111 and a light blocking part 112. The light transmission part 111 is disposed to overlap, i.e., correspond to, a display area DA of the display panel 50, so the light emitted from the display panel 50 transmits through the light transmission part 111 to be perceived by a user. The light blocking part 112 is disposed to overlap, i.e., to correspond to, a non-display area of the display panel 50, i.e., an area excluded from the display area DA, so the light emitted from the display panel 50 is blocked by the light blocking part 112. In another exemplary embodiment, the window substrate 110 may have an opening portion corresponding to the display area DA.

The touch screen panel 120 is coupled to the window substrate 110 to sense a position of touch event occurring on the window substrate 110. In the present exemplary embodiment, the touch screen panel 120 is a capacitive type touch screen panel. However, embodiments are not limited thereto, e.g., the touch screen panel 120 may be a resistive film type touch screen panel, an ultrasonic type touch screen panel, or an infrared type touch screen panel, instead of the capacitive type touch screen panel.

The first adhesive member 130 is provided on the touch screen panel 120 to adhere the touch screen panel 120 to the display panel 50. For example, the first adhesive member 130 may be between, e.g., directly between, a bottom of the touch screen panel 120 and a top of the terminal part 58 of the display panel 50. In the present exemplary embodiment, the first adhesive member 130 has a thin film shape corresponding to the display panel 50 and the touch screen panel 120, and is a transparent adhesive film through which light is transmitted, e.g., an optical clear adhesive (OCA) film.

The sub-adhesive member 115 is interposed between the window substrate 110 and the touch screen panel 120 to adhere the touch screen panel 120 to the window substrate 110. In the present exemplary embodiment, the sub-adhesive member 115 has a similar shape and optical property as those of the first adhesive member 130.

As illustrated in FIGS. 1-2, the first end portion P1 of the driving circuit film 80 is adhered to the first adhesive member 130, so the terminal part 58 coupled to the first end portion P 1 is fixed to the window assembly 100. That is, the terminal part 58 is affixed to the touch screen panel 120 via the first end portion P 1 of the driving circuit film 80 and via the first adhesive member 130. For example, as illustrated in FIG. 2, end portions of the terminal part 58 and the first end portion P1 of the driving circuit film 80 may overlap each other, and may further overlap and be parallel to an end portion of the touch screen panel 120.

In contrast, if a terminal part of a display panel and an end portion of the driving circuit film are not affixed to a window assembly, the terminal part may be subjected to a continuous stress. That is, if the terminal part 58 and the first end portion P1 are not affixed to the window assembly 100, the terminal part 58 may bend toward the driving circuit board 90 due to an elastic force of the driving circuit film 80 having the bent portion P3 and the flexible property of the terminal part 58. As such, signal lines and/or bonding pads in the terminal part 58 may be damaged, e.g., due to bending and/or stress.

However, according to example embodiments, since the terminal part 58 is fixed to the window assembly 100, the terminal part 58 is prevented from being bent, e.g., toward the circuit board 90. Thus, the signal lines and/or the bonding pads, which are formed in the terminal part 58, are prevented from being damaged due to stress, e.g., bending.

In the present exemplary embodiment shown in FIG. 2, the first end portion P1 is adhered to the first adhesive member 130. However, embodiments are not limited thereto. For example, according to another exemplary embodiment, both the first end portion P1 of the driving circuit film 80 and an end portion of the display substrate 51, e.g., a portion of the terminal part 58, may be adhered to the first adhesive member 130, as will be described with reference to FIG. 3.

FIG. 3 illustrates a cross-sectional view showing a display apparatus according to another exemplary embodiment of the present disclosure. In FIG. 3, same reference numerals denote same elements in FIGS. 1 and 2, and thus detailed descriptions of the same elements will be omitted.

Referring to FIG. 3, a display apparatus 201 may further include a second adhesive member 135. A first surface of the second adhesive member 135 may be adhered to the first end portion P1 of the driving circuit film 80 and to the terminal part 58, and a second surface of the second adhesive member 135 may be adhered to the first adhesive member 130. For example, the first surface of the second adhesive member 135 may be in direct contact with both the first end portion P1 and a portion of the terminal part 58, and the second surface of the second adhesive member 135 may be in direct contact with the first adhesive member 130. Therefore, the terminal part 58 may be adhered to the first adhesive member 130 by the second adhesive member 135. In other words, the terminal part 58 is affixed to the window assembly 100 by the first and second adhesive members 130 and 135.

In the present exemplary embodiment, when the optical film 55 has a first thickness T1, the second adhesive member 135 has a second thickness T2 that is substantially the same as the first thickness T1. That is, a space between the terminal part 58 and the first adhesive member 130 may be filled with the second adhesive member 135. Thus, the terminal part 58 is maintained in a flat state while being fixed to the window assembly 100.

In the present exemplary embodiment, the second adhesive member 135 may be, but not limited to, an adhesive tape. According to another exemplary embodiment, the second adhesive member 135 may be formed by curing an adhesive material.

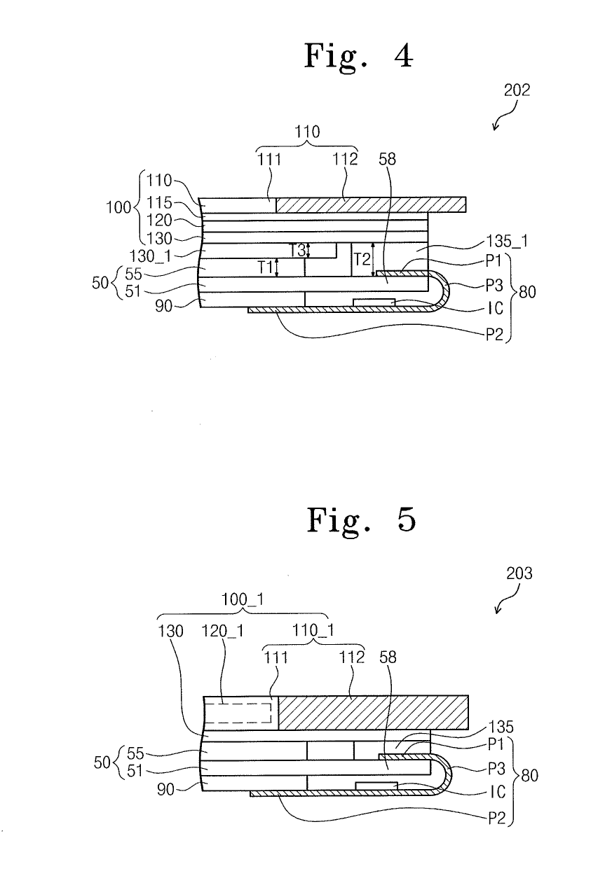

FIG. 4 illustrates a cross-sectional view showing a display apparatus according to another exemplary embodiment of the present disclosure. In FIG. 4, the same reference numerals denote the same elements in FIGS. 1-3, and thus detailed descriptions of the same elements will be omitted.

Referring to FIG. 4, when comparing the structure of the display apparatus 201 shown in FIG. 3 with a structure of a display apparatus 202 shown in FIG. 4, a portion of a first adhesive member 130_1 facing a terminal part 58 is removed. Further, a first surface of a second adhesive member 135_1 is adhered to the first end portion P1 of the driving circuit film 80 and to the terminal part 58, and a second surface of the second adhesive member 135_1 is directly adhered to the touch screen panel 120 in the display apparatus 202 shown in FIG. 4. Thus, the terminal part 58 and the first end portion P1 are fixed to the window assembly 100 only by the second adhesive member 135_1.

In addition, when the optical film 55 has a first thickness T1 and the first adhesive member 130_1 has a third thickness T3, the second adhesive member 135_1 has a second thickness T2 that equals a sum of the first thickness T1 and the third thickness T3. That is, a space between the terminal part 58 and the touch screen panel 120 is filled with the second adhesive member 135_1. Thus, the terminal part 58 is maintained in a flat state while being fixed to the window assembly 100.

FIG. 5 illustrates a cross-sectional view showing a display apparatus according to another exemplary embodiment of the present disclosure. In FIG. 5, the same reference numerals denote the same elements in FIGS. 1-4, and thus detailed descriptions of the same elements will be omitted.

Referring to FIG. 5, when comparing the structure of the display apparatus 201 shown in FIG. 3 with a structure of a display apparatus 203 shown in FIG. 5, a window assembly 100_1 of the display apparatus 203 may include a window substrate 110_1, a touch screen panel 120_1, the a first adhesive member 130. Further, the touch screen panel 120_1 is built in the window substrate 110_1. Therefore, the sub-adhesive member 115 described with reference to FIGS. 1 and 2 may be omitted from the display apparatus 203.

Similar to the exemplary embodiment shown in FIG. 3, the first end portion P1 of the driving circuit film 80 and the terminal part 58 are fixed to the window assembly 100_1 by the first adhesive member 130 and the second adhesive member 135.

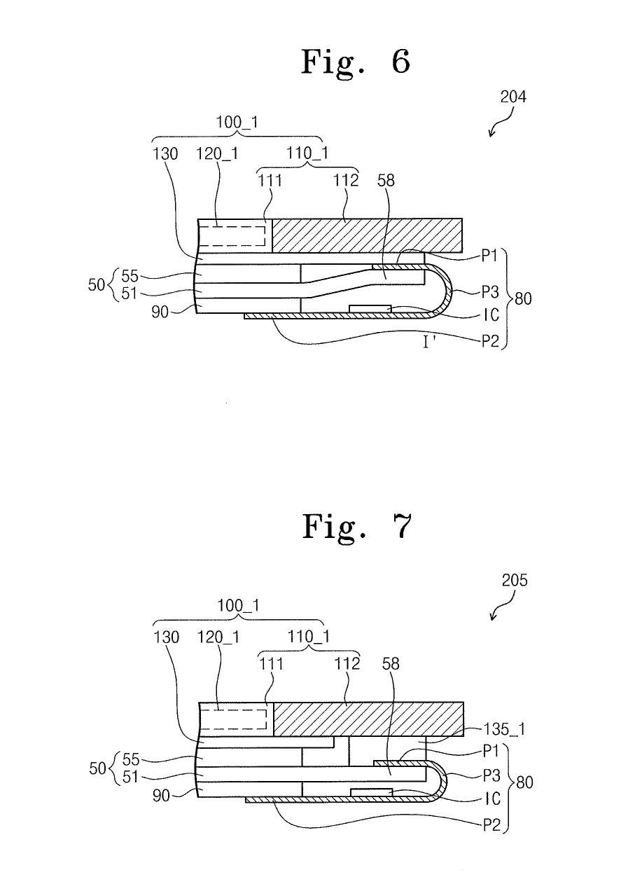

FIG. 6 illustrates a cross-sectional view showing a display apparatus according to another exemplary embodiment of the present disclosure. In FIG. 6, the same reference numerals denote the same elements in FIGS. 1-5, and thus detailed descriptions of the same elements will be omitted.

Referring to FIG. 6, similar to the exemplary embodiment shown in FIG. 5, the touch screen panel 120_1 of the window assembly 100_1 is built in the window substrate 110_1 of a display apparatus 204. In addition, similar to the exemplary embodiment shown in FIG. 2, the first end portion P1 of the driving circuit film 80 and the terminal part 58 are adhered to the first adhesive member 130 to fix the terminal part 58 to the window assembly 100_1.

FIG. 7 illustrates a cross-sectional view showing a display apparatus according to another exemplary embodiment of the present disclosure. In FIG. 7, the same reference numerals denote the same elements in FIGS. 1-6, and thus detailed descriptions of the same elements will be omitted.

Referring to FIG. 7, similar to the exemplary embodiment shown in FIG. 5, the touch screen panel 120_1 of the window assembly 100_1 is built in the window substrate 110_1 of a display apparatus 205. In addition, similar to the exemplary embodiment shown in FIG. 4, one surface of the second adhesive member 135_1 is adhered to the first end portion P1 of the driving circuit film 80 and the terminal part 58, and the other surface of the second adhesive member 135_1 is adhered to the first adhesive member 130. Thus, the terminal part 58 is fixed to the window assembly 100_1.

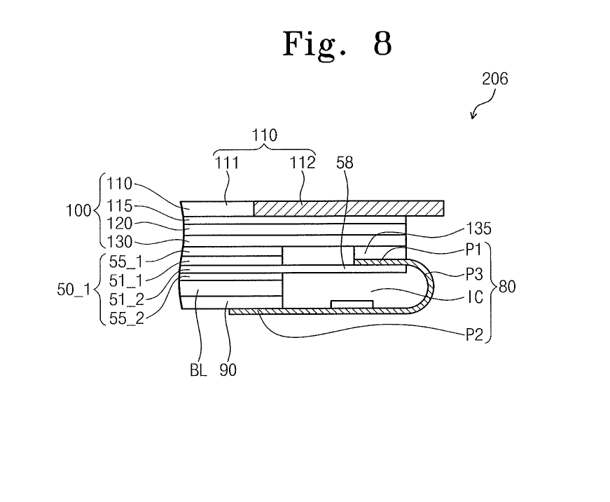

FIG. 8 illustrates a cross-sectional view showing a display apparatus according to another exemplary embodiment of the present disclosure. In FIG. 8, the same reference numerals denote the same elements in FIGS. 1-7, and thus detailed descriptions of the same elements will be omitted.

Referring to FIG. 8, a display apparatus 206 includes a display panel 50_1. The display panel 50_1 may be, but not limited to, a liquid crystal display panel. In this case, the display panel 50_1 may include an array substrate 512 having thin film transistors and pixel electrodes electrically connected to the thin film transistors, an opposite substrate 51_1 facing the array substrate 51_2, and a liquid crystal layer (not shown) interposed between the array substrate 51_2 and the opposite substrate 51_1.

A first optical film 55_1 may be disposed between the opposite substrate 51_1 and the first adhesive member 130, and the first optical film 55_1 may be adhered to the opposite substrate 51_1 and the first adhesive member 130. In addition, a second optical film 55_2 may be adhered to a lower surface of the array substrate 51_2. In the present exemplary embodiment, each of the first and second optical films 55_1 and 55_2 may include a polarizing film, or a polarizing film and a phase difference film.

As described above, in the case that the display panel 50_1 is the liquid crystal display panel, the display apparatus 206 further includes a backlight assembly BL disposed between a driving circuit film 90 and the display panel 50_1. The backlight assembly BL outputs light to the display panel 50_1, and thus the display panel 50_1 displays an image using the light emitted from the backlight assembly BL.

By way of summary and review, stress, which is caused by a connection structure between the conventional flexible display panel and other parts of the display apparatus, may be continuously applied to a specific portion of the flexible display panel. In this case, the conventional flexible display panel may be damaged by the stress or the connection structure between the conventional flexible display panel and other parts may weaken, thereby causing a progressive functional defect in the display apparatus.

However, according to example embodiments, an edge of the display panel may be affixed to the window assembly, thereby preventing or substantially minimizing bending of the edge due to the stress. That is, a terminal part coupled to a driving circuit film is fixed to the window assembly, so the ten final part may be prevented from being damaged, e.g., due to stress caused by the driving circuit film and applied to the terminal part, and an electrical connection between the driving circuit film and the terminal part may be prevented from becoming unstable. Therefore, the terminal part of the display panel may be prevented from being damaged and the electrical connection between the driving circuit film and the terminal part may be stably maintained, thereby improving reliability of the display apparatus.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display apparatus, comprising:
a flexible display panel including a terminal part, the terminal part being configured to receive a driving signal;
a window assembly covering the display panel; and
a driving circuit film coupled to the terminal part of the display panel, the driving circuit film being configured to apply the driving signal to the display panel, and at least one of the terminal part and the driving circuit film being fixed to the window assembly.

2. The display apparatus as claimed in claim 1, wherein the driving circuit film includes a bent portion, the bent portion being bent away from the window assembly.

3. The display apparatus as claimed in claim 1, further comprising a driving circuit board parallel to the window assembly, the display panel being between the driving circuit board and the window assembly,
wherein a first end portion of the driving circuit film is coupled to the terminal part of the display panel, a second end portion of the driving circuit film is coupled to the driving circuit board, and a bent portion of the driving circuit film is bent from the terminal part to the driving circuit board.

4. The display apparatus as claimed in claim 1, wherein the window assembly includes:
a window substrate including a light transmission part corresponding to a display area of the display panel;
a touch screen panel on the window substrate, the touch screen panel being configured to sense a position of a touch event on the window substrate; and
a first adhesive member on the touch screen panel, the first adhesive member connecting the touch screen panel to the display panel.

5. The display apparatus as claimed in claim 4, wherein a portion of the driving circuit film coupled to the terminal part of the display panel is connected to the first adhesive member, the terminal part of the display panel being fixed to the window assembly via the driving circuit film and the first adhesive member.

6. The display apparatus as claimed in claim 4, further comprising a second adhesive member, a first surface of the second adhesive member being adhered to at least one of the terminal part and a portion of the driving circuit film coupled to the terminal part, and a second surface of the second adhesive member being adhered to the first adhesive member.

7. The display apparatus as claimed in claim 6, wherein the display panel further comprises:
a display substrate configured to emit light and to display an image using the emitted light; and
an optical film having a first surface adhered to the display substrate and a second surface, which faces the first surface, adhered to the first adhesive member, the second adhesive member having a same thickness as a thickness of the optical film.

8. The display apparatus as claimed in claim 7, wherein the display panel is an organic electroluminescent light emitting display panel.

9. The display apparatus as claimed in claim 7, further comprising a backlight assembly facing the window assembly, the backlight assembly being configured output light to the display panel, and the display panel being a liquid crystal display panel between the backlight assembly and the window assembly.

10. The display apparatus as claimed in claim 4, further comprising a second adhesive member on at least one of the terminal part and a portion of the driving circuit film coupled to the terminal part, the second adhesive member being directly on the touch screen panel and affixing the terminal part to the window assembly.

11. The display apparatus as claimed in claim 4, wherein the first adhesive member is transparent, the first adhesive member having a shape corresponding to the touch screen panel.

12. The display apparatus as claimed in claim 1, wherein the window assembly includes:
a window substrate including a light transmission part corresponding to a display area of the display panel;
a touch screen panel on the window substrate, the touch screen panel being configured to sense a position of a touch event on the window substrate; and
a first adhesive member on the window substrate, the first adhesive member connecting the window substrate to the display panel.

13. The display apparatus as claimed in claim 12, wherein at least one of the terminal part and a portion of the driving circuit film coupled to the terminal part is adhered to the first adhesive member, the terminal part being fixed to the window assembly via the portion of the driving circuit film and the first adhesive member.

14. The display apparatus as claimed in claim 12, further comprising a second adhesive member adhered to at least one of the terminal part and a portion of the driving circuit film coupled to the terminal part, the terminal part being fixed to the window assembly via the portion of the driving circuit film, the first adhesive member, and the second adhesive member.

15. The display apparatus as claimed in claim 14, wherein the display panel further comprises:
a display substrate configured to emit light to display an image using the light; and
an optical film including a first surface adhered to the display substrate and a second surface, which faces the first surface, adhered to the first adhesive member, the second adhesive member having a same thickness as a thickness of the optical film.

16. The display apparatus as claimed in claim 12, further comprising a second adhesive member adhered to at least one of the terminal part and the portion of the driving circuit film coupled to the terminal part, the second adhesive member being directly on the window substrate, the terminal part being affixed to the window assembly via the portion of the driving circuit film and the second adhesive member.

17. The display apparatus as claimed in claim 1, wherein the driving circuit film includes a driving chip configured to generate the driving signal, the driving chip being on the driving circuit film in a chip-on-flexible board structure.
